(19) United States
(12) Patent Application Publication
(10) Pub. No.: US 2018/0284037 A1
(43) Pub. Date: Oct. 4, 2018

(54) INSPECTION DEVICE, INSPECTION METHOD, AND METHOD OF PRODUCING FILM ROLL

(71) Applicant: Sumitomo Chemical Company, Limited, Tokyo (JP)

(72) Inventors: Koji KASHU, Niihama-shi (JP); Yoshitaka SHINOMIYA, Dalseong-gun (KR)

(21) Appl. No.: 15/936,626

(22) Filed: Mar. 27, 2018

(30) Foreign Application Priority Data
Mar. 30, 2017 (JP) 2017-067712
Jun. 30, 2017 (JP) 2017-129782

(51) Int. Cl. G01N 23/16; B65H 18/08; B65H 26/02; G01N 23/083; G01N 23/18

(52) U.S. Cl. CPC G01N 23/16; B65H 18/08; B65H 2701/1842; G01N 23/083; G01N 23/18; B65H 26/02

(57) ABSTRACT

A defect inspection device includes: a radiation source configured to emit an electromagnetic wave radially to a separator roll; a TDI sensor configured to detect the electromagnetic wave which has passed through the separator roll; and a moving mechanism configured to move an inspection region of the separator roll with a distance kept substantially constant between the radiation source and the separator roll and with a distance kept substantially constant between the radiation source and the TDI sensor.

This Nonprovisional application claims priority under 35 U.S.C. § 119 on Patent Application No. 2017-067712 filed in Japan on Mar. 30, 2017 and Patent Application No. 2017-129782 filed in Japan on Jun. 30, 2017, the entire contents of which are hereby incorporated by reference.

### TECHNICAL FIELD

The present invention relates to an inspection device, an inspection method, and a method of producing a film roll.

### BACKGROUND ART

A lithium-ion secondary battery includes a positive electrode and a negative electrode that are separated by a porous separator. A separator may have a defect, such as a foreign object adhered to the separator, during the production of the separator. This necessitates inspecting the separator for a defect. Particularly, in a case where the defect is an electrically conductive foreign object such as metal, the foreign object may cause a short circuit inside the lithium-ion secondary battery.

For example, Patent Literature 1 discloses an X-ray foreign object detection device configured to emit an X-ray to an inspection target object being transferred for detection of a foreign object.

### CITATION LIST

### Patent Literature

[Patent Literature 1]

Japanese Patent Application Publication Tokukai No. 2004-61479 (Publication date: Feb. 26, 2004)

### SUMMARY OF INVENTION

### Technical Problem

Separator rolls are produced by (i) slitting (cutting) a single separator original sheet into a plurality of separators in accordance with the size of lithium-ion secondary batteries to be produced and (ii) winding each separator around a core.

As a separator original sheet is being slit into separators, a metal foreign object resulting from a metal blade tends to adhere to the separators. It is thus preferable to inspect, for a defect, each separator produced by slitting the separator original sheet. A metal foreign object results also from, for example, a sliding part of a transfer roller. It is thus preferable to inspect, for any defect, a separator which has been wound around a core into a separator roll and then will not come into contact with a roller.

For an inspection target object of a relatively large thickness such as a separator roll, the X-ray foreign object detection device disclosed in Patent Literature 1 may unfortunately have a decreased inspection accuracy due to a difference in inspection position between a front surface and a back surface of the inspection target object, the front surface and the back surface facing each other in the thickness direction of the inspection target object.

Aspects of the present invention have been attained in view of the above problem, and it is an object of the present invention to provide an inspection device and the like which can prevent a decreased inspection accuracy resulting from the thickness of an inspection target object.

### Solution to Problem

In order to attain the above object, an inspection device in accordance with an aspect of the present invention includes: a radiation source configured to emit an electromagnetic wave radially to an inspection target object in a thickness direction of the inspection target object; a TDI sensor, disposed opposite from the radiation source with respect to the inspection target object, configured to detect the electromagnetic wave which has passed through the inspection target object; and a moving mechanism configured to move an inspection region of the inspection target object with a distance kept substantially constant between the radiation source and the inspection target object and with a distance kept substantially constant between the radiation source and the TDI sensor.

In order to attain the above object, an inspection method in accordance with an aspect of the present invention includes: an emitting step including emitting an electromagnetic wave radially from a radiation source to an inspection target object in a thickness direction of the inspection target object; a moving step including moving an inspection region of the inspection target object; and a detecting step including detecting, with use of a TDI sensor, the electromagnetic wave which has passed through the inspection target object, the moving step including moving the inspection region with a distance kept substantially constant between the radiation source and the inspection target object and with a distance kept substantially constant between the radiation source and the TDI sensor.

### Advantageous Effects of Invention

An aspect of the present invention yields the effect of preventing a decreased inspection accuracy resulting from the thickness of the inspection target object.

### BRIEF DESCRIPTION OF DRAWINGS

(a) and (b) of FIG. 1 are diagrams each schematically illustrating the configuration of a slitting apparatus in accordance with Embodiment 1.

(a) to (e) of FIG. 2 are diagrams each schematically illustrating the configuration of a separator roll in accordance with Embodiment 1.

(a) to (c) of FIG. 3 are diagrams each schematically illustrating the configuration of a defect inspection device in accordance with Embodiment 1.

(a) and (b) of FIG. 4 are diagrams each illustrating an example of how the defect inspection device illustrated in FIG. 3 carries out defect inspection.

FIG. 5 is an elevational view schematically illustrating the configuration of a modification of the defect inspection device illustrated in FIG. 3.

FIG. 6 is a diagram schematically illustrating the configuration of a modification of the moving mechanism illustrated in FIG. 3.

FIG. 7 is a diagram schematically illustrating the configuration of another modification of the moving mechanism illustrated in FIG. 3.

FIG. 8 is a diagram schematically illustrating the configuration of a defect inspection device in accordance with Embodiment 2.

(a) of FIG. 9 is a top view illustrating the defect inspection device, and (b) of FIG. 9 is a side view illustrating an operating state of the defect inspection device.

(a) to (c) of FIG. 10 are diagrams each illustrating an orientation changing mechanism included in the defect inspection device.

(a) and (b) of FIG. 11 are side views each illustrating a modification of a mount included in the defect inspection device.

(a) to (h) of FIG. 12 are diagrams each schematically illustrating the configuration of a defect inspection device in accordance with Embodiment 3 and each illustrating an operating state of the defect inspection device.

FIG. 13 is a diagram illustrating a modification of the defect inspection device illustrated in FIG. 12.

### DESCRIPTION OF EMBODIMENTS

### Embodiment 1

The following description will discuss an embodiment of the present invention with reference to FIGS. 1 to 5. In Embodiment 1, an example case will be described in which an inspection device in accordance with an embodiment of the present invention is applied to a defect inspection device for inspecting a separator roll for any foreign object in the separator roll. Note, however, that the inspection device in accordance with an embodiment of the present invention can inspect not only a separator roll but also various kinds of inspection target objects having a relatively large thickness.

[Process of Producing Separator Roll]

First, the description below deals with a process of producing a separator roll (film roll) which is an inspection target object of a defect inspection device (inspection device) in accordance with Embodiment 1.

(a) and (b) of FIG. 1 are diagrams each schematically illustrating the configuration of a slitting apparatus 6 configured to slit a separator original sheet into separators. Specifically, (a) of FIG. 1 schematically illustrates the configuration of the entire slitting apparatus 6, and (b) of FIG. 1 schematically illustrates an arrangement before and after slitting a separator original sheet.

The separator 12 is a porous film or a nonwoven fabric that allows movement of lithium ions between a positive electrode and a negative electrode of, for example, a lithium-ion secondary battery (battery) while separating the positive electrode and the negative electrode. The separator 12 contains, for example, polyolefin such as polyethylene or polypropylene as a material.

The separator 12 may include a porous film and a heat-resistant layer on a surface of the porous film to have heat resistance. The heat-resistant layer contains, for example, wholly aromatic polyamide (aramid resin) as a material.

That is, the separator 12 may be a layered porous film including (i) a porous film containing a polyolefin and (ii) a functional layer(s) such as a heat-resistant layer and an adhesive layer. The functional layer contains resin. Examples of the resin include: a polyolefin such as polyethylene or polypropylene; a fluorine-containing polymer such as polyvinylidene fluoride (PVDF), polytetrafluoroethylene, or a PVDF-hexafluoropropylene copolymer; an aromatic polyamide; a rubber such as a styrene-butadiene copolymer and a hydride thereof, a methacrylate ester copolymer, an acrylonitrile-acrylic ester copolymer, or a styrene-acrylic ester copolymer; a polymer having a melting point or glass transition temperature of not lower than 180° C.; and a water-soluble polymer such as polyvinyl alcohol, polyethylene glycol, cellulose ether, sodium alginate, polyacrylic acid, polyacrylamide, or polymethacrylic acid. The functional layer may contain a filler made of an organic substance or an inorganic substance. The inorganic filler is made of, for example, an inorganic oxide such as silica, magnesium oxide, alumina, aluminum hydroxide, or boehmite. Alumina has crystal forms such as α-alumina, β-alumina, γ-alumina, and θ-alumina, and any of the crystal forms may be used. The resin and the filler may each contain (i) only one kind or (ii) two or more kinds in combination. In a case where the functional layer contains a filler, the filler may be contained in an amount of not less than 1% by volume to not more than 99% by volume of the functional layer.

The separator 12 should desirably contain as small an amount of water as possible for a minimized influence on the defect inspection described later. The defect inspection during the defect inspecting step described later involves causing an electromagnetic wave such as X rays to pass through a separator 12 in order to inspect the separator 12, wound around a core, for a foreign object inside the separator 12. Since water decreases the transmittance of an electromagnetic wave such as X rays, the separator 12 containing a large amount of water will undesirably decrease the accuracy of the defect inspection.

The separator 12 may contain water in an amount of preferably up to approximately 2000 ppm. This makes it possible to (i) prevent a decrease in the transmittance of an electromagnetic wave such as X rays and (ii) accurately inspect a separator 12 wound around a core for a defect inside the separator 12 during the defect inspecting step described later.

The separator 12 may preferably have a width (hereinafter referred to as “product width”) suitable for an application product such as a lithium-ion secondary battery. For an improved productivity, however, a separator 12 is first produced to have a width that is equal to or larger than the product width. Then, after having been produced to have a width equal to or larger than the product width, the separator is slit into a separator(s) having the product width.

The separator 12 produced by slitting an original sheet during the slitting step and wound around a core may preferably have a width (that is, the dimension in the TD) of, for example, approximately not less than 30 mm to not more than 100 mm. If the separator 12 has an excessively large width, an electromagnetic wave such as X rays will not easily pass through the separator 12 for the defect inspection during the defect inspecting step described later, with the result of a decrease in the accuracy of the defect inspection. In view of that, the separator 12 having a width of approximately not more than 100 mm makes it possible to (i) prevent a decrease in the transmittance of an electromagnetic wave such as X rays and (ii) accurately inspect the separator 12 wound around a core for a defect inside the separator 12 during the defect inspecting step described later.

Note that the “separator width” means a dimension of the separator which extends in a direction substantially perpendicular to a lengthwise direction of the separator and to a thickness direction of the separator. In the description below, a wide separator having not yet been slit is referred to as an “original sheet”. Moreover, “slit” means to cut off a separator in a lengthwise direction (i.e., a direction in which a film flows in production), and “cut” means to cut the separator in a transverse direction. The transverse direction means a direction that is substantially perpendicular to the lengthwise direction of the separator and to the thickness direction of the separator, and is synonymous with a widthwise direction of the separator.

The slitting apparatus 6 is configured to slit an original sheet. The slitting apparatus 6 includes a rotatably supported cylindrical wind-off roller 61, transfer rollers 62 to 69, and wind-up rollers 70U and 70L.

In the slitting apparatus 6, a cylindrical core c around which an original sheet is wound is fit on the wind-off roller 61.

The original sheet is wound off from the core c to a route U or L. The original sheet having been wound off is transferred to the transfer roller 68 via the transfer rollers 63 to 67. During the step of transferring the original sheet from the transfer roller 67 to the transfer roller 68, the original sheet is slit into a plurality of separators 12 (slitting step). The slitting apparatus 6 includes a slitting device (not shown in FIG. 1) disposed near the transfer roller 68 and configured to slit an original sheet into a plurality of separators 12.

After the slitting step, some of the separators 12 produced by slitting the original sheet are each wound around a cylindrical core u fit on the wind-up roller 70U, whereas the other of the separators 12 are each wound around a cylindrical core 1 fit on the wind-up roller 70L (separator winding step).

Note that the term “separator roll” refers to a roll which includes (i) a separator 12 produced by slitting an original sheet and (ii) a core (bobbin) around which the separator 12 is wound into a roll form. In Embodiment 1, after a separator roll has been produced through the separator winding step, the separator roll is inspected for any foreign object inside the separator 12 (wound around the core) during the defect inspecting step described later. During the slitting step described above, a foreign object tends to result from, for instance, a metal slitting blade being chipped and the resulting piece adhering to a surface of a slit separator 12. The defect inspecting step may thus preferably be carried out after the slitting step. This makes it possible to efficiently inspect, during the defect inspecting step, a separator for any foreign object resulting from the slitting step, during which a foreign object tends to result.

Separator rolls that have been determined as non-defective during the defect inspecting step are later packed together in a package during a packaging step for storage and shipment.

[Configuration of Separator Roll]

Next, the description below deals with the configuration of a separator roll (an inspection target object, a film roll) in accordance with Embodiment 1. (a) to (e) of FIG. 2 are diagrams each schematically illustrating the configuration of a separator roll 10 in accordance with Embodiment 1. Specifically, (a) of FIG. 2 illustrates a separator 12 that has not been wound off from a core 8, (b) of FIG. 2 illustrates the separator 12 illustrated in (a) of FIG. 2 from a different angle, (c) of FIG. 2 illustrates the separator 12 that has been wound off from the core 8, (d) of FIG. 2 illustrates the separator 12 illustrated in (c) of FIG. 2 from a different angle, and (e) of FIG. 2 illustrates the core 8 from which the separator 12 has been wound off and removed.

As illustrated in (a) and (b) of FIG. 2, a separator roll 10 includes a core 8 and a separator 12 wound around the core 8. The separator 12 has been produced by slitting an original sheet as described above. Among a plurality of surfaces of a separator roll 10, the outer peripheral surface of the separator 12 wound in the shape of a roll is referred to as “outer peripheral surface 10a”. One of side surfaces of the separator roll 10, which side surfaces face each other across the outer peripheral surface 10a and are substantially circular in outer shape, is referred to as a “first side surface 10b”, and the other of the side surfaces is referred to as a “second side surface 10c”.

The core 8 includes an outer cylindrical member (outer tubular member) 81, an inner cylindrical member (inner tubular member) 82, and a plurality of ribs 83.

The outer cylindrical member 81 is a cylindrical member around which a separator 12 is to be wound to be in contact with the outer peripheral surface 81a of the outer cylindrical member 81. The inner cylindrical member 82 is a cylindrical member, provided on a side of an inner peripheral surface 81b of the outer cylindrical member 81, being smaller in diameter than the outer cylindrical member 81. The ribs 83 are support members that (i) extend from an outer peripheral surface 82a of the inner cylindrical member to the inner peripheral surface 81b of the outer cylindrical member 81 and that (ii) support the outer cylindrical member 81 from the side of the inner peripheral surface 81b. In Embodiment 1, eight ribs 83 in total are provided at equal intervals along the circumference of the core 8.

The core 8 has a first through hole 8a provided nearly in the center thereof and a plurality of second through holes 8b (in Embodiment 1, eight second through holes 8b) provided around the first through hole 8a. The first through hole 8a is defined by the inner cylindrical member 82 (inner peripheral surface 82b of the inner cylindrical member 82). The second through holes 8b are defined by the outer cylindrical member 81, the inner cylindrical member 82, and the ribs 83.

As illustrated in (c) and (d) of FIG. 2, the separator 12 has an end attached to the core 8 with an adhesive tape 130. Specifically, the separator 12 has an end fixed to the outer peripheral surface 81a of the core 8 (outer cylindrical member 81) with use of the adhesive tape 130. An end of the separator 12 may be fixed to the outer peripheral surface 81a by, instead of using the adhesive tape 130, applying an adhesive directly to an end of the separator 12, using a clip, or the like method.

As illustrated in (e) of FIG. 2, the core 8 is preferably configured such that the respective central axes of the outer cylindrical member 81 and the inner cylindrical member 82 substantially match each other. However, the configuration of the core 8 is not limited to such a configuration. Furthermore, dimensions of the outer cylindrical member 81 and the inner cylindrical member 82, such as the respective thicknesses, widths, and radii thereof, can be designed as appropriate according to, for example, the type or size of the separator 12 to be wound.

Further, the ribs 83 are provided so as to have equal intervals therebetween, at respective positions dividing the circumference of the core 8 into eight equal portions. Each of the ribs 83 is provided so as to be substantially perpendicular to both the outer cylindrical member 81 and the inner cylindrical member 82. Note that the number of ribs 83 and the placement interval of the ribs 83 are not limited to the above configuration.

The core 8 contains ABS resin as a material thereof. Note that the core 8 may contain, as a material thereof, a resin other than ABS resin such as polyethylene resin, polypropylene resin, polystyrene resin, or vinyl chloride resin. Further, the core 8 should preferably not contain metal, paper, or fluorocarbon resin as a material thereof.

[Configuration of Defect Inspection Device]

Next, the description below deals with the configuration of a defect inspection device in accordance with Embodiment 1. (a) to (c) of FIG. 3 are diagrams each schematically illustrating the configuration of a defect inspection device 1 in accordance with Embodiment 1. Specifically, (a) of FIG. 3 is an elevational view of the defect inspection device 1, (b) of FIG. 3 is a top view of the defect inspection device 1, and (c) of FIG. 3 is a side view of the defect inspection device 1.

The defect inspection device 1 inspects the separator roll 10 for any foreign object inside the separator 12 wound around the core 8 (defect inspecting step). Specifically, the defect inspection device 1 in accordance with Embodiment 1 emits an electromagnetic wave (electromagnetic ray) to the separator roll 10 to perform an inspection for any foreign object inside the separator 12.

The defect inspection device 1 is surrounded by a wall containing, for example, lead to prevent, for example, an X ray from passing therethrough easily so that an electromagnetic wave used does not leak outward.

As illustrated in (a) to (c) of FIG. 3, the defect inspection device 1 includes a radiation source 2, a moving mechanism 3, and a TDI sensor 4. In Embodiment 1, a direction parallel to a center line A of a turning shaft 322 of the moving mechanism 3 corresponds to an X-axis direction, a direction, perpendicular to the X axis, of going toward the TDI sensor 4 from the radiation source 2 corresponds to a Y-axis direction, and a direction perpendicular to the X axis and the Y axis corresponds to a Z-axis direction.

(Radiation Source)

The radiation sources 2 each emit an electromagnetic wave R radially to the separator roll 10 in a thickness direction (Y-axis direction) of the separator roll 10. The “thickness direction of a/the separator roll”, which is identical to the widthwise direction of the separator 12 wound around the core 8, means a direction perpendicular to the first side surface 10b of the separator roll 10 and to the second side surface 10c of the separator roll 10.

In Embodiment 1, the defect inspection device 1 includes two radiation sources 2 each of which emits an electromagnetic wave R radially. Each radiation source 2 is disposed on the center line A. A distance between the radiation sources 2 (a distance between the center of one of the radiation sources 2 and the center of the other of the radiation sources 2) is so set as to be substantially identical to the diameter of the core 8 of the separator roll 10, in order to prevent, among electromagnetic waves R having been emitted radially by each of the radiation sources 2, an electromagnetic wave R parallel to the Y-axis direction from being blocked by the core 8. By setting the distance between the radiation sources 2 in this way, it is possible to prevent a shadow of the core 8 from entering the TDI sensor 4 during the detection of an electromagnetic wave R with use of the TDI sensor 4. Furthermore, in order to prevent the respective electromagnetic waves R emitted from the individual radiation sources 2 from being mixed with each other, a method of placing a blocking object near the radiation sources 2, a method of adjusting the individual radiation sources 2 to emit the respective electromagnetic waves at different angles, or other method may be selected and employed as appropriate.

As the electromagnetic wave R emitted by each of the radiation sources 2, for example, electromagnetic rays (e.g., X rays or γ rays) can be suitably used. By using X rays, in particular, as the electromagnetic wave R, it is possible to provide a defect inspection device 1 that is inexpensive and easy to use. Note, however, that the kind of electromagnetic wave R to be used can be selected as appropriate according to, for example, the type or size of the inspection target object.

Alternatively, the radiation sources 2 may be each configured to emit an electromagnetic wave R to a separator roll 10 in such a manner that the electromagnetic wave R strikes not only the separator 12 wound around the core 8 but also the core 8.

(Moving Mechanism)

The moving mechanism 3 moves the separator roll 10. The moving mechanism 3 includes: a mount 31 configured to hold the separator roll 10; and driving sections 32 configured to cause the mount 31 to turn.

The mount 31 includes a frame 311, a support plate 312, a holding mechanism 313, and coupling rods 314. The frame 311 is a frame-like member substantially in the shape of a square. The support plate 312 is provided between two first opposite edges of the frame 311 (two edges that face each other in the Z-axis direction) so as to be in contact with the inner surfaces of these two first opposite edges. Further, the coupling rods 314 are provided so as to protrude through the outer surfaces of two second opposite edges of the frame 311 (two edges that face each other in the X-axis direction).

The support plate 312 is a plate-shaped member for supporting the holding mechanism 313. The support plate 312 includes (i) long edges extending in the Z-axis direction and (ii) short edges extending in the X-axis direction. The length of each of the short edges (width of the support plate 312) is so set as to be shorter than the diameter of the core 8. By setting the length of each of the short edges of the support plate 312 so as to be shorter than the diameter of the core 8, it is possible to prevent a shadow of the support plate 312 from entering the TDI sensor 4 during the detection of an electromagnetic wave R with use of the TDI sensor 4.

The holding mechanism 313 is a shaft member configured to rotatably hold the separator roll 10. The holding mechanism 313 is provided so as to protrude through a center portion of the support plate 312, and is engaged in the first through hole 8a of the core 8 of the separator roll 10.

The holding mechanism 313 is able to rotate clockwise or counterclockwise. Thus, with rotation of the holding mechanism 313, the separator roll 10 can be rotated substantially about the holding mechanism 313 that extends in the thickness direction of the separator roll 10.

In Embodiment 1, the holding mechanism 313 is inserted into the first through hole 8a of the core 8 from the first side surface 10b side of the separator roll 10 so that the holding mechanism 313 holds the separator roll 10. In this manner, the separator roll 10 is set in the defect inspection device 1 in such a manner that at least a portion of the separator 12 wound around the core 8 is present between the radiation sources 2 and the TDI sensor 4 in a state in which the first side surface 10b faces the radiation sources 2 and the second side surface 10c faces the TDI sensor 4.

The coupling rods 314 are each a rod member for coupling the frame 311 to a corresponding one of the driving sections 32. The coupling rods 314 are provided in such a manner that two coupling rods 314 are provided in parallel to each other so as to protrude through one of the outer surfaces of the two second opposite edges of the frame 311 (two edges that face each other in the X-axis direction) and other two coupling rods 314 are provided in parallel to each other so as to protrude through the other one of the outer surfaces of the two second opposite edges of the frame 311 (two edges that face each other in the X-axis direction).

The driving sections 32 are configured to cause the mount 31 to turn substantially about the center line A. Each of the driving sections 32 is coupled to a corresponding one of the two second opposite edges of the frame 311 (two edges that face each other in the X-axis direction) via the corresponding coupling rods 314.

Each of the driving sections 32 includes turning rollers 321 and turning shafts 322. Each of the turning rollers 321 is a cylindrical member configured such that the corresponding coupling rods 314 are fixed on an outer peripheral surface of a corresponding one of the turning rollers 321. Each of the turning shafts 322 is engaged in a corresponding one of the turning rollers 321 so as to be in contact with an inner peripheral surface of the corresponding one of the turning rollers 321.

Each of the turning shafts 322 is a shaft member capable of being turned clockwise and counterclockwise substantially about the center line A by a motor (not illustrated). The driving section 32 causes the turning shafts 322 to turn together, thereby causing the turning rollers 321 to turn.

According to the moving mechanism 3, the operation of the driving section 32 is controlled so that the separator roll 10 held by the mount 31 can be moved along a circular path substantially centered around the radiation source 2 (center line A).

(TDI Sensor)

The time delay integration (TDI) sensor 4 is a detector capable of detecting an electromagnetic wave R which has passed through the separator 12. In a case where the radiation source 2 is configured to emit X rays, the TDI sensor 4 is a detector capable of detecting X rays, and in a case where the radiation source 2 is configuration to emit γ rays, the TDI sensor 4 is a detector capable of detecting γ rays.

The TDI sensor 4 is disposed opposite from the radiation source 2 with respect to the separator roll 10. The TDI sensor 4 is configured such that a plurality of cells (sensor elements) are arranged in a direction (X-axis direction) perpendicular to a direction of movement (turning) of the separator roll 10, and a plurality of cells (sensor elements) are arranged in a direction (Z-axis direction) parallel to the direction of movement (turning) of the separator roll 10. That is, the TDI sensor 4 is configured such that a plurality of unit line sensors are arranged in the Z-axis direction.

The TDI sensor 4, when it has detected the electromagnetic wave R emitted by the radiation source 2, outputs to an image processing section (not illustrated) an electric signal corresponding to the intensity of the electromagnetic wave R detected. The image processing section generates a captured image on the basis of the electric signal having been outputted from the TDI sensor 4.

[Method for Defect Inspection]

Next, the description below deals with an example of how the defect inspection device 1 in accordance with Embodiment 1 carries out defect inspection (defect inspecting step). (a) and (b) of FIG. 4 are diagrams each illustrating an example of how the defect inspection device 1 illustrated in FIG. 3 carries out defect inspection. Specifically, (a) of FIG. 4 is a side view illustrating a moving state of the separator roll 10 in the defect inspection device 1, and (b) of FIG. 4 is a top view illustrating image-captured regions of the separator roll 10. Note that for convenience of explanation, (a) of FIG. 4 omits the moving mechanism 3.

In the defect inspection device 1, the TDI sensor detects the electromagnetic wave R having passed through the separator roll 10, while an inspection region of the separator roll 10 is moved with a distance kept substantially constant between the radiation source 2 and the separator roll 10 and with a distance kept substantially constant between the radiation source 2 and the TDI sensor 4. Specifically, in Embodiment 1, when viewed from the X-axis direction as illustrated in (a) of FIG. 4, the TDI sensor 4 detects the electromagnetic wave R having passed through the separator 12 while the separator roll 10 is not subjected to parallel translation (that is, the separator roll 10 is not in rectilinear motion) but is moved along a circular path C substantially centered around the radiation source 2 (that is, the separator roll 10 is in circular motion). The configuration such that the separator roll 10 is moved along the circular path C makes substantially equal an angle at which the electromagnetic wave R strikes the separator roll 10, as compared to the configuration such that the separator roll 10 is subjected to parallel translation. This makes it possible to reduce the error in detection position of the TDI sensor 4 which error results from the thickness of the separator roll 10.

Note that in Embodiment 1, the configuration such that the moving mechanism 3 causes the separator roll 10 to move along the circular path C is employed. Alternatively, other configuration may be employed, provided that the inspection region of the separator roll 10 can be moved with a distance kept substantially constant between the radiation source 2 and the separator roll 10 and with a distance kept substantially constant between the radiation source 2 and the TDI sensor 4.

Further, the TDI sensor 4 may be bowed so as to be substantially parallel to the circular path C. This allows the TDI sensor 4 to suitably detect the electromagnetic wave R having been emitted radially by the radiation source 2 and allows an angle at which the electromagnetic wave R enters the TDI sensor 4 to make substantially equal. Thus, it is possible to enhance a detection accuracy of the TDI sensor 4.

In Embodiment 1, the defect inspection device 1 causes the separator roll 10 to make a to-and-fro movement (simple pendulum motion) twice or more times between a first position P1 and a second position P2 both of which are located on the circular path C. Then, an image of each portion of the separator 12 is captured during each movement of the separator roll 10 from the first position P1 to the second position P2, and eventually a captured image of the entire separator 12 is created.

Specifically, in the defect inspection device 1, while the electromagnetic wave R is emitted by the radiation source 2 from the first side surface 10b side of the separator roll 10 (emitting step), the moving mechanism 3 (driving section 32) causes the separator roll 10 to move from the first position P1 to the second position P2 (moving step).

In Embodiment 1, the angle (feed angle) which the separator roll 10 at the first position P1 forms with the separator roll 10 at the second position P2 is set to approximately 30 degrees. In other words, in Embodiment 1, a pendulum angle θ of the separator roll 10 is set to approximately 15 degrees. The pendulum angle θ of the separator roll 10 can be set as appropriate according to, for example, the size of the separator roll 10 and the size of the TDI sensor 4. However, the pendulum angle θ of the separator roll 10 is preferably not more than 60 degrees. A pendulum angle θ of greater than 60 degrees decreases the angle at which the electromagnetic wave R strikes the separator roll 10 and increases the length of the path through which the electromagnetic wave R passes through the separator roll 10 (that is, the length of the path through which the electromagnetic wave R travels within the separator roll 10). This can decrease the intensity of the electromagnetic wave R detected by the TDI sensor 4 and thus can lead to the failure to detect a foreign object appropriately. Therefore, the pendulum angle θ is preferably not more than 60 degrees, and more preferably not more than 40 degrees.

While the separator roll 10 is moved from the first position P1 to the second position P2, the defect inspection device 1 captures an image of a portion of the separator 12 by detecting the electromagnetic wave R which has passed through the separator 12 with use of the TDI sensor 4 (detecting step). In Embodiment 1, the defect inspection device 1, when the separator roll 10 is positioned at a third position P3 which is a midpoint position between the first position P1 and the second position P2, captures an image of the separator 12 with use of the TDI sensor 4 so that the captured image includes an image of the separator 12.

The defect inspection device 1, in a case where the separator roll 10 reaches the second position P2, moves the separator roll 10 from the second position P2 to the first position P1 with use of the moving mechanism 3 (driving section 32). The defect inspection device 1 is configured such that, while the separator roll 10 is moved from the second position P2 to the first position P1, detection of the electromagnetic wave R is not made by the TDI sensor 4, and the moving mechanism 3 (holding mechanism 313) rotates the separator roll 10 by a predetermined angle.

By repeating such an operation, the defect inspection device 1 can capture an image of a different region of the separator 12 with use of the TDI sensor 4 during each to-and-fro movement of the separator roll 10 between the first position P1 and the second position P2. For example, as illustrated in (b) of FIG. 4, the defect inspection device 1 can capture an image of a first region R1 of the separator 12 during a first image-capturing operation, capture an image of a second region R2 of the separator 12 during a second image-capturing operation, and capture an image of a third region R3 of the separator 12 during a third image-capturing operation.

Thus, assuming that while the separator roll 10 makes one to-and-fro movement, the separator roll 10 is rotated at approximately 14 degrees with use of the moving mechanism 3 (holding mechanism 313) and one image-capturing operation is carried out, an image of the entire separator 12 can be captured by performing thirteen image-capturing operations in total. Note that the angle (predetermined angle) at which the separator roll 10 is rotated for each to-and-fro movement can be set as appropriate according to, for example, the size of the separator roll 10 and the size of the TDI sensor 4.

How many seconds it takes to perform a single image-capturing operation may be adjusted as appropriate according to, for example, the time length necessary for inspection, the sensitivity of the TDI sensor 4, and/or the number of products to be processed. For example, a single image-capturing operation can be performed within four seconds. A shorter time period for a single image-capturing operation is preferable because it makes shorter a tact time necessary to inspect a single separator roll 10.

Depending on, for example, the time length necessary to inspect a single separator roll 10, the sensitivity of the TDI sensor 4, and/or the number of products to be processed (that is, the number of separator rolls 10 to be inspected), the defect inspection device 1 may inspect a plurality of separator rolls 10 simultaneously by, for instance, (i) simultaneously capturing an image of a plurality of separator rolls 10 that are placed on top of one another in the X direction or (ii) simultaneously capturing an image of a plurality of separator rolls 10 arranged next to one another on the ZY plane.

The defect inspection device 1 may be configured such that through the movement of the separator roll 10 relative to the radiation source section 2, the radiation source 2 may switch between emitting and not emitting an electromagnetic wave R, or the TDI sensor 4 switches between detecting and not detecting an electromagnetic wave R. The defect inspection device 1 may, in other words, be configured such that while the radiation source 2 constantly emits an electromagnetic wave R, the TDI sensor 4 switches between detecting and not detecting an electromagnetic wave R. With this configuration, it is possible to obtain respective captured images of different regions in a manner similar to the case in which the radiation source 2 emits an electromagnetic wave R fragmentarily. It is preferable that the TDI sensor 4 should switch between detecting and not detecting an electromagnetic wave R through the relative movement of the separator roll 10. Turning the radiation source 2 on and off frequently may causes an emitted electromagnetic wave to be unstable and thus may cause a disadvantage such as the radiation source 2 having a shorter life.

The defect inspection device 1 is configured to create a captured image of the entire ring-shaped separator 12 by (i) extracting necessary regions from those captured images obtained in the manner as described above and (ii) connecting the necessary regions. Then, the defect inspection device 1 analyzes the created captured image of the entire separator 12 to perform an inspection for any foreign object inside the separator 12.

By connecting a plurality of captured images as described above, it is possible to three-dimensionally determine the position of a foreign object. It is also possible to detect even a thin foreign object without being missed.

Note that the foreign object which the defect inspection device 1 can detect may be made of any of various materials such as metal and carbon. The foreign object which the defect inspection device 1 can detect may have any of various sizes. The foreign object may be, as an example, 100 μm and have a thickness of approximately 50 μm. When the present specification specifies the size of a foreign object simply as, for example, “100 μm” without specifying it as the thickness or width, that dimension means the diameter of the circumscribed sphere of the foreign object.

The foreign object as a defect to be detected tends to, in a case where it has a large specific gravity, be detectable even if it is small. Assuming that the defect to be detected is a metal foreign object, in a case where a metal having a specific gravity of approximately 6 is detectable with a size down to, for example, approximately 100 μm under a certain inspection condition, a metal having a specific gravity of approximately 2 is detectable with a size down to approximately 300 μm. The defect inspection device 1 may be configured such that the size of a foreign object as a detection target is set as appropriate according to the kind (that is, specific gravity) of a metal foreign object as a detection target.

The defect inspection device 1 is capable of detecting a small foreign object in a case where the defect inspection device 1 has extended the time for inspection by, for example, extending the exposure time period and/or carrying out a plurality of image-capturing operations for the same region of a separator roll 10. Thus, the relationship described above between the specific gravity of a metal foreign object as a detection target and its size assumes a fixed inspection time length.

As the respective specific gravities of typical metals, Fe has approximately 7.8, Al has approximately 2.7, Zn has approximately 7.1, stainless steel has approximately 7.7, Cu has approximately 8.5, and brass has approximately 8.5. The metal material of a foreign object 5 is, however, not limited to these examples.

For instance, setting the defect inspection device 1 to detect any foreign object that is not less than 100 μm and using the defect inspection device 1 for defect inspection of a separator roll 10 makes it possible to select, from among various separator rolls 10 that are produced through a process of producing a separator roll 10 and that (possibly) contain foreign objects of various sizes, any separator roll 10 that contains a foreign object that is not less than 100 μm.

Removing, during the production process, any separator roll 10 in which the defect inspection device 1 has detected a foreign object that is not less than 100 μm makes it possible to select, from among various separator rolls 10 (possibly) contain foreign objects of various sizes, any separator roll 10 that contains only a small number of foreign objects which are not less than 100 μm or that is free from any foreign object which is not less than 100 μm.

Stated differently, including, in the process of producing a separator roll 10, a defect inspecting step involving the use of the defect inspection device 1 makes it possible to produce, from among various separator rolls 10 (possibly) containing foreign objects of various sizes, a separator roll 10 that contains only a small number of foreign objects which are not less than 100 μm or that is free from any foreign object which is not less than 100 μm.

In particular, a separator roll 10 containing only a small number of foreign objects that are not less than 100 μm has a low possibility that a foreign object adhering to the separator 12 causes a failure.

Including, in the process of producing a separator roll 10, a defect inspecting step involving the use of the defect inspection device 1 as described above makes it possible to produce a separator roll that has only a small number of defects such as a foreign object.

The defect inspecting step may, as described above, preferably be carried out after the slitting step and before the packaging step during the process of producing a separator roll 10. This configuration makes it possible to efficiently inspect a separator roll for any foreign object generated in the slitting step.

Including the defect inspecting step in the process of producing a separator roll 10 eliminates the need to inspect a separator 12 for an adhering foreign object after the step of packaging the separator roll 10, specifically during a production process of assembling a battery with use of the separator 12 wound around the core 8.

When the defect inspection device 1 is used to inspect a separator 12 wound around a core 8 for a defect inside the separator 12, the defect inspection device 1 may preferably be in a clean environment, for instance, be placed in a clean room. The clean environment may preferably have a class of, for example, not more than 100,000. Carrying out defect inspection in such an environment makes it possible to reduce the risk of a foreign object adhering to the separator 12 during or after the inspection. Further, the space surrounded by a wall containing, for example, lead which space may be inside or outside the defect inspection device 1 may preferably be also in a clean environment such as the above. With this configuration, the defect inspection device 1 is capable of accurately inspecting a separator 12, wound around a core 8, for a defect inside the separator 12.

The defect inspection device 1 may preferably be configured to, after an image is captured of a separator roll 10 and before an image is captured of another separator roll 10 (that is, after the end of each image-capturing cycle), return each section moved for capturing an image of the separator roll 10 (such as the holding mechanism 313) to its initial state. This prevents an inspection failure, a redundant inspection, and a malfunction such as starting an image-capturing operation while the previous image-capturing operation has not finished. The defect inspection device 1 may preferably be configured to return each section to its initial state after the end of each image-capturing cycle as described above also for each defect inspection device described later of Embodiment 2 and its subsequent embodiments.

[Recap of Defect Inspection Device]

As described above, the defect inspection device 1 in accordance with Embodiment 1 includes: the radiation source 2 configured to emit an electromagnetic wave R radially to the separator roll 10 in a thickness direction of the separator roll 10; the moving mechanism 3 configured to move the separator roll 10; and the TDI sensor 4, disposed opposite from the radiation source 2 with respect to the separator roll 10, configured to detect an electromagnetic wave R which has passed through the separator 12, wherein the moving mechanism 3 causes the separator roll 10 to move along the circular path C substantially centered around the radiation source 2.

In the defect inspection device 1, while the separator roll 10 is moved along the circular path C substantially centered around the radiation source 2, the TDI sensor 4 detects the electromagnetic wave R which has passed through the separator 12. This configuration makes substantially equal an angle at which the electromagnetic wave R strikes the separator 12, and thus makes it possible to reduce the error in detection position of the TDI sensor 4 which error results from the thickness of the separator roll 10.

Thus, according to Embodiment 1, it is possible to provide the defect inspection device 1 which can prevent a decreased inspection accuracy resulting from the thickness of the separator roll 10.

[Modifications of Defect Inspection Device]

(Modification 1)

The above description has dealt with the defect inspection device 1 which is configured such that one image-capturing operation is performed on the separator roll 10 during each to-and-fro movement of the separator roll 10 between the first position P1 and the second position P2. However, the configuration of the defect inspection device 1 in accordance with an embodiment of the present invention is not limited to such a configuration. Alternatively, the defect inspection device 1 may be configured such that two image-capturing operations are performed on the separator roll 10 during each to-and-fro movement of the separator roll 10 between the first position P1 and the second position P2.

Specifically, the defect inspection device 1 is configured to capture images of the separator 12 by the TDI sensor detecting the electromagnetic wave R having passed through the separator 12 both during a movement of the separator roll 10 from the first position P1 to the second position P2 and during a movement of the separator roll 10 from the second position P2 to the first position P1.

In this configuration, the separator roll 10 is rotated by a predetermined angle both at a time when the separator roll 10 has reached the second position P2 from the first position P1 and at a time when the separator roll 10 has reach the first position P1 from the second position P2.

This configuration allows the defect inspection device 1 to capture respective images of two different regions of the separator roll 10 during each to-and-fro movement of the separator roll 10 between the first position P1 and the second position P2. This makes it possible to shorten a tact time necessary for inspection of the entire separator roll 10.

(Modification 2)

The above description has also dealt with the defect inspection device 1 which is configured to have two radiation sources 2. However, the configuration of the defect inspection device 1 in accordance with an embodiment of the present invention is not limited to such a configuration. For example, the defect inspection device 1 may be configured to have a single radiation source 2 or may be configured to have three or more single radiation sources 2. That is, the number of radiation sources 2 used can be changed as appropriate according to, for example, the type, shape, or size of the inspection target object.

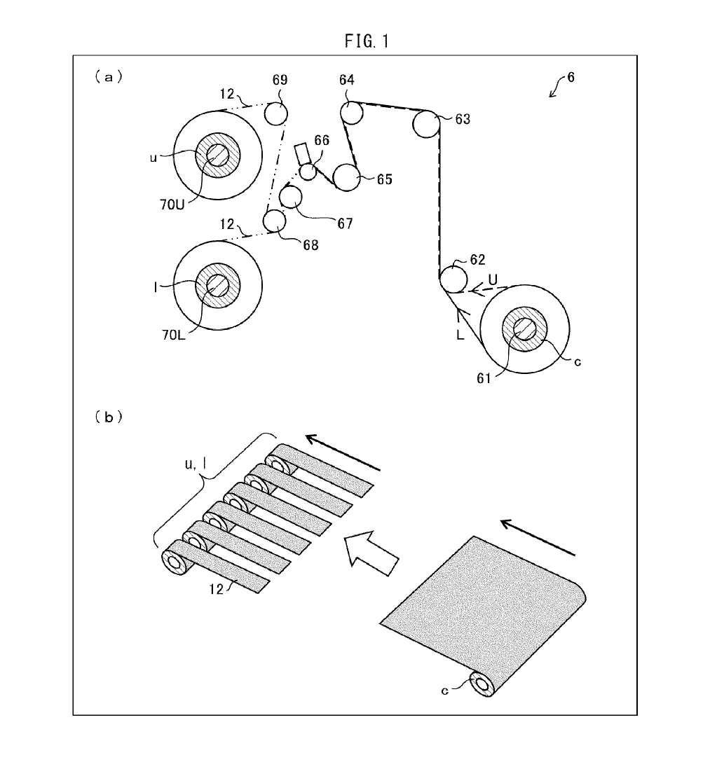

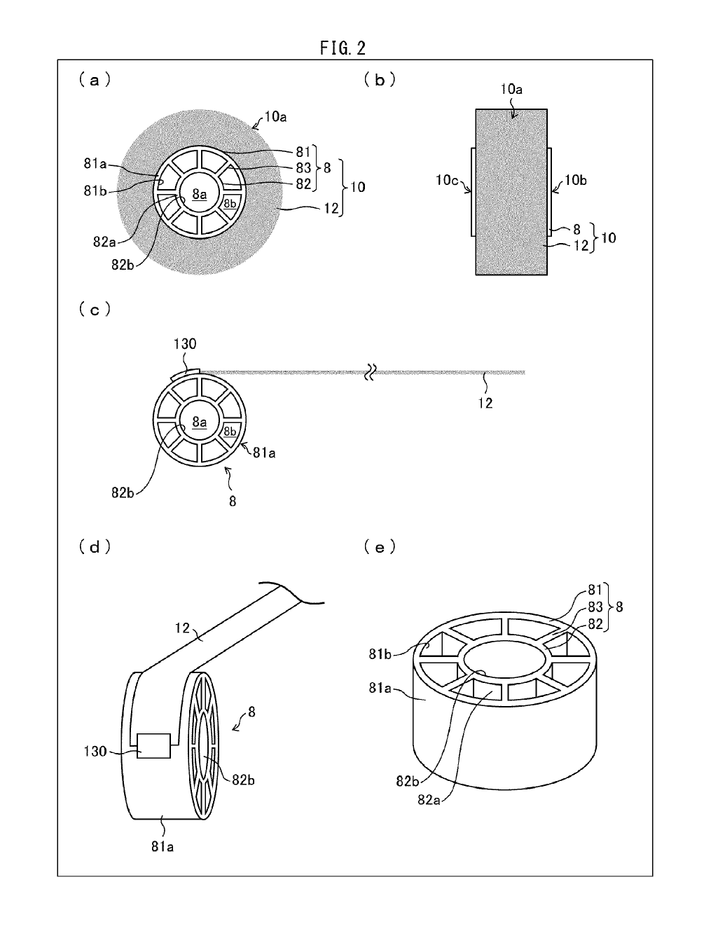

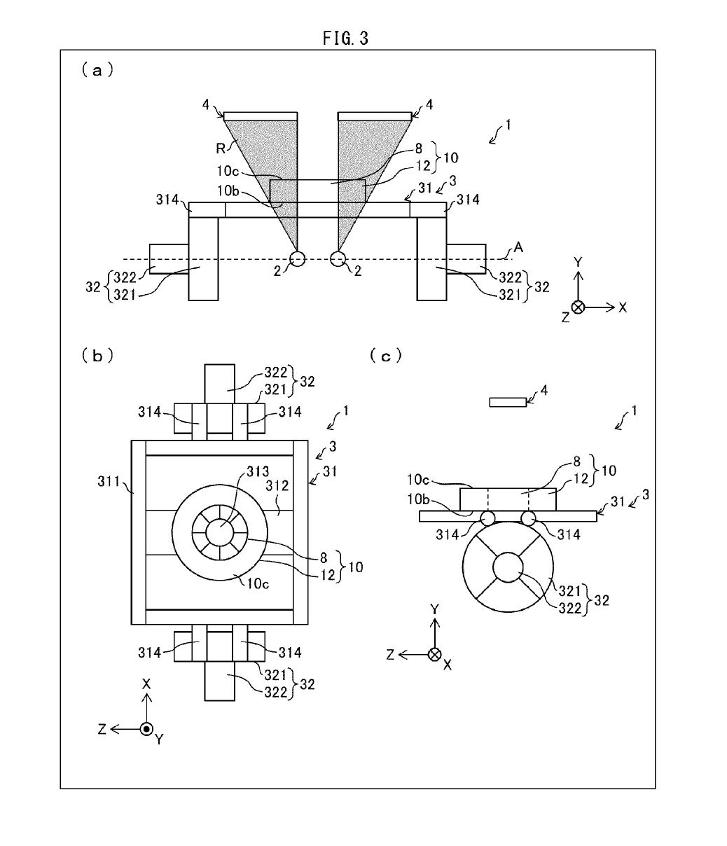

FIG. 5 is an elevational view schematically illustrating the configuration of a modification of the defect inspection device 1 illustrated in FIG. 3. As illustrated in FIG. 5, the defect inspection device 1 may be configured to have a single radiation source 2. Even with such a configuration, moving the separator roll 10 along the circular path C substantially centered around the radiation source 2 makes substantially equal an angle at which the electromagnetic wave R strikes the separator roll 10. This makes it possible to reduce the error in detection position of the TDI sensor 4 which error results from the thickness of the separator roll 10.

Note, however that, in a case where the defect inspection device 1 is configured to have a single radiation source 2, a shadow of the core 8 will enter the TDI sensor 4 during the detection of an electromagnetic wave R with use of the TDI sensor 4. Thus, the defect inspection device 1 is preferably configured to have two or more radiation sources 2 in a case where the inspection target object is the separator roll 10 as in Embodiment 1.

(Modification 3)

The above description has also dealt with the moving mechanism 3 which is configured to include: the mount 31 configured to rotatably hold the separator roll 10; and the driving section 32 configured to cause the mount 31 to turn. The moving mechanism in accordance with an embodiment of the present invention is, however, not limited to such a configuration. The moving mechanism is configured to be capable of moving the separator roll 10 along a circular path substantially centered around the radiation source 2.

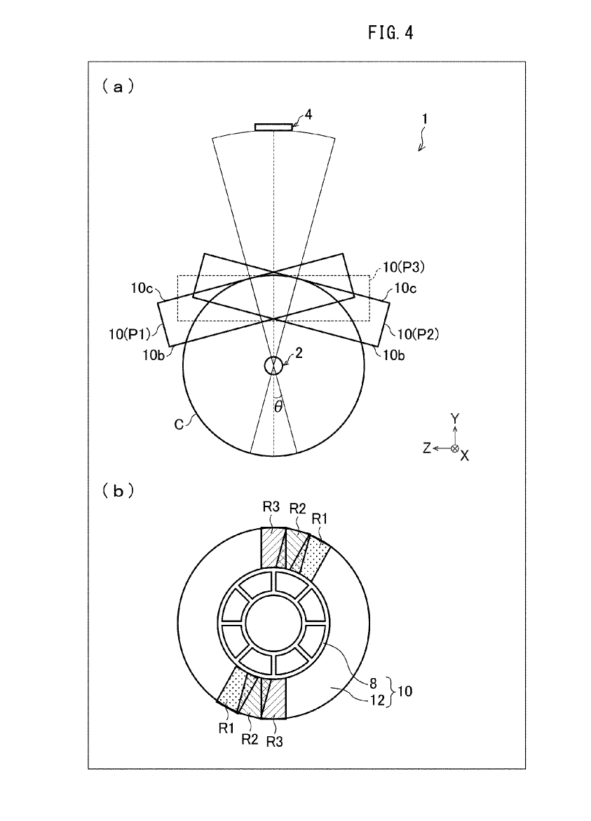

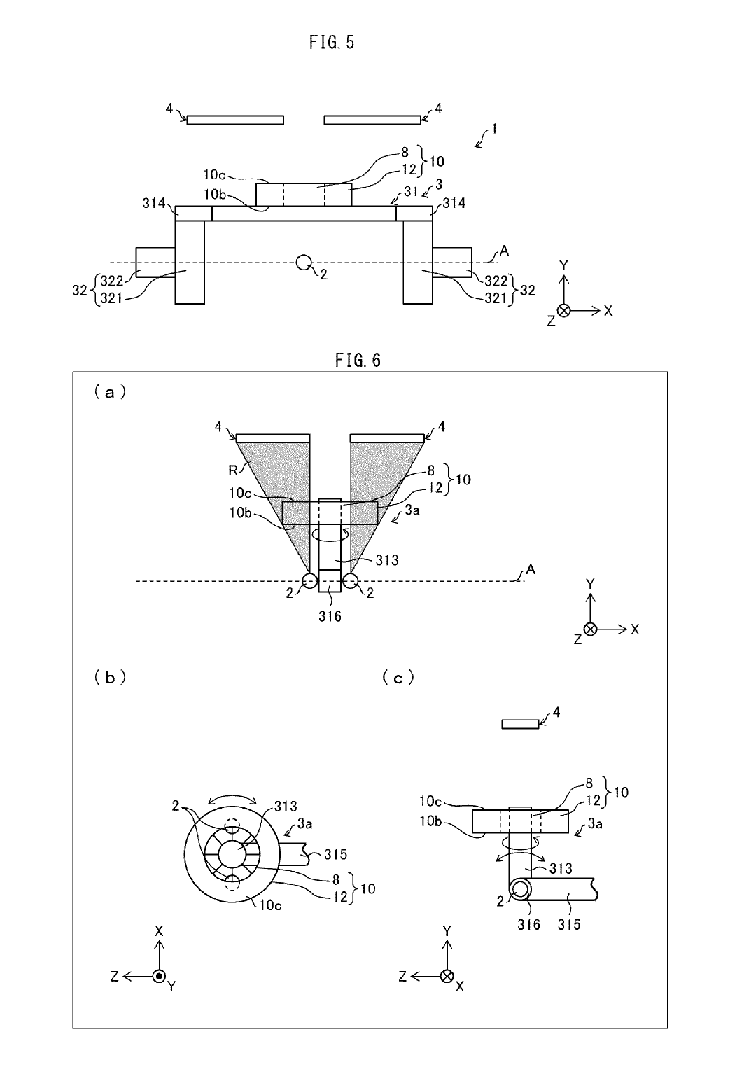

FIG. 6 is a diagram schematically illustrating the configuration of a modification of the moving mechanism 3 illustrated in (a) to (c) of FIG. 3. Specifically, (a) of FIG. 6 is an elevational view of a moving mechanism 3a, (b) of FIG. 6 is a top view of the moving mechanism 3a, and (c) of FIG. 6 is a side view of the moving mechanism 3a.

(a) to (c) of FIG. 6 each illustrate an example of the moving mechanism 3a configured to include a robot arm. As illustrated in (a) to (c) of FIG. 6, the moving mechanism 3a includes: a holding mechanism 313 configured to rotatably hold the separator roll 10; and an arm 315 configured to support the holding mechanism 313.

The arm 315 has a turning shaft 316 at its forward end, and the holding mechanism 313 is connected to the turning shaft 316. This allows the holding mechanism 313 to be turnable substantially about a center line A of the turning shaft 316. Thus, with radiation sources 2 disposed on the center line A of the turning shaft 316, it is possible to detect an electromagnetic wave R having passed through the separator 12 with use of the TDI sensor 4, while the separator roll 10 is moved along a circular path substantially centered around the radiation sources 2 (that is, the separator roll 10 is in circular motion).

With the moving mechanism 3a configured to include a robot arm as described above, it is possible to perform transfer of the separator roll 10 and defect inspection of the separator roll 10 with use of the moving mechanism 3a. Thus, it is possible to shorten a tact time necessary for defect inspection of the separator roll 10.

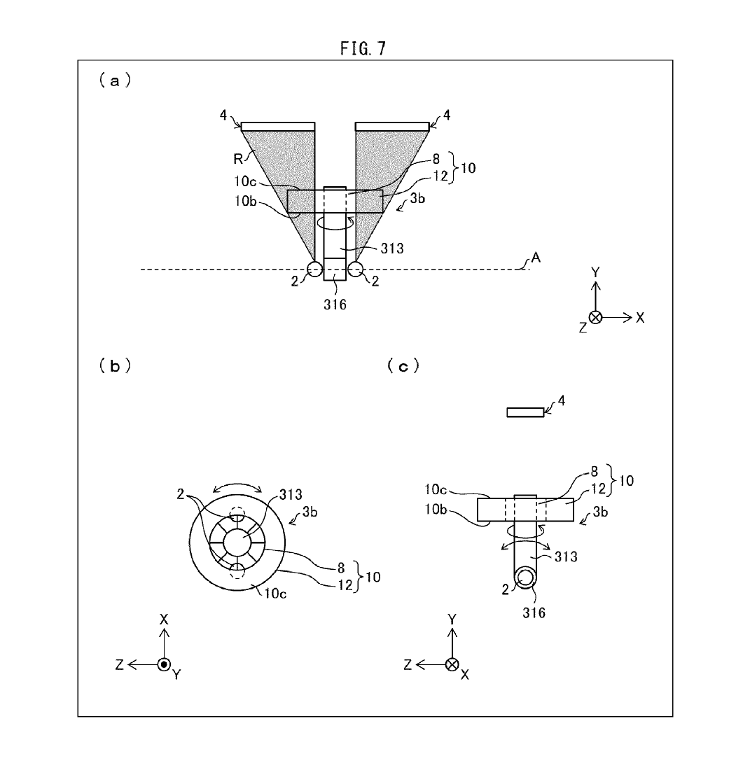

FIG. 7 is a diagram schematically illustrating the configuration of another modification of the moving mechanism 3 illustrated in (a) to (c) of FIG. 3. Specifically, (a) of FIG. 7 is an elevational view of a moving mechanism 3b, (b) of FIG. 7 is a top view of the moving mechanism 3b, and (c) of FIG. 7 is a side view of the moving mechanism 3b.

As illustrated in (a) to (c) of FIG. 7, the moving mechanism 3b includes: a holding mechanism 313 configured to rotatably hold the separator roll 10; and a turning shaft 316 configured to turnably support the holding mechanism 313. Even in a case where the moving mechanism 3b having such a configuration is employed, with radiation sources 2 disposed on the center line A of the turning shaft 316, it is possible to detect an electromagnetic wave R having passed through the separator 12 with use of the TDI sensor 4, while the separator roll 10 is moved along a circular path substantially centered around the radiation sources 2 (that is, the separator roll 10 is in circular motion).

### Embodiment 2

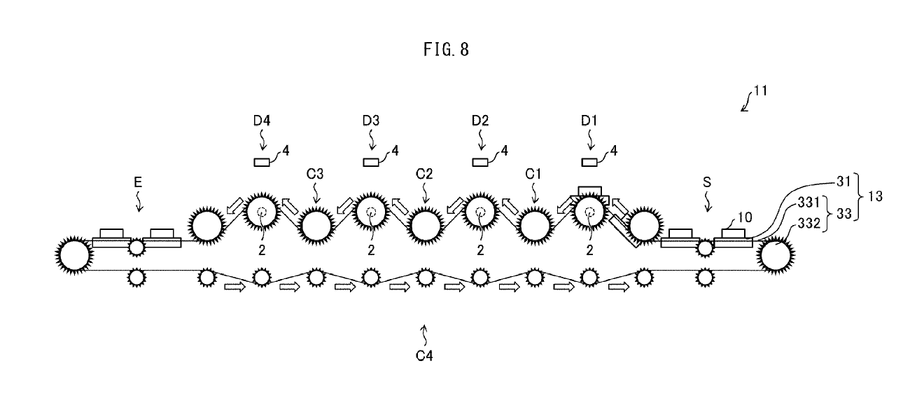

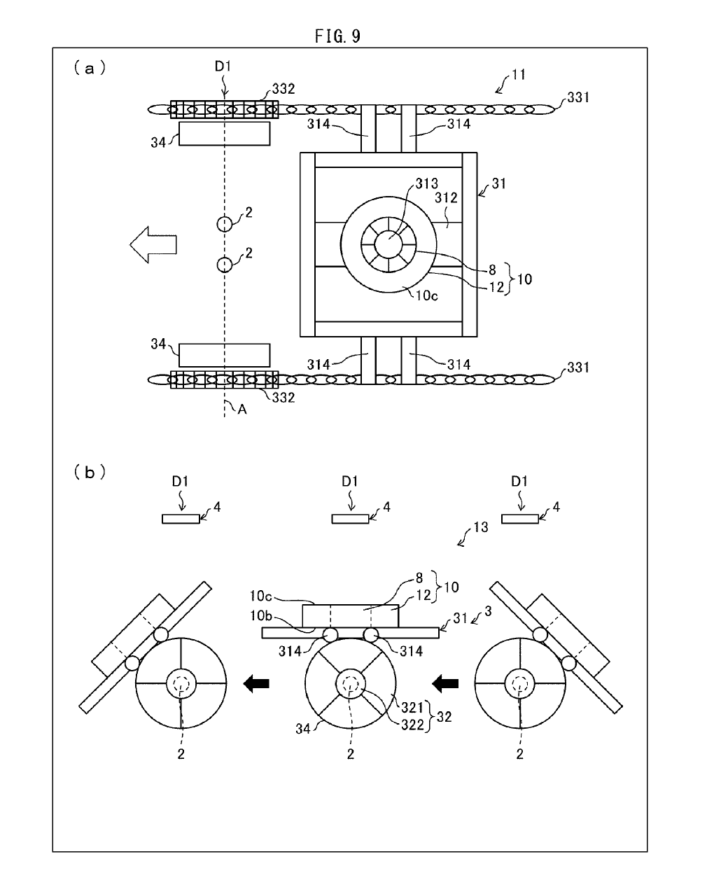

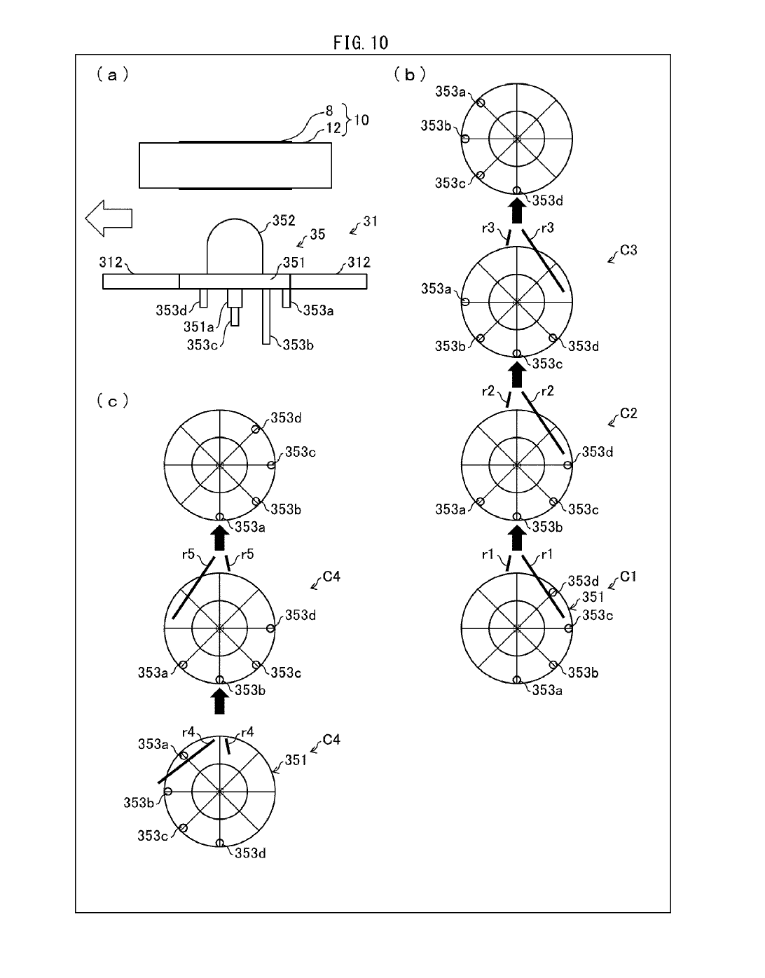

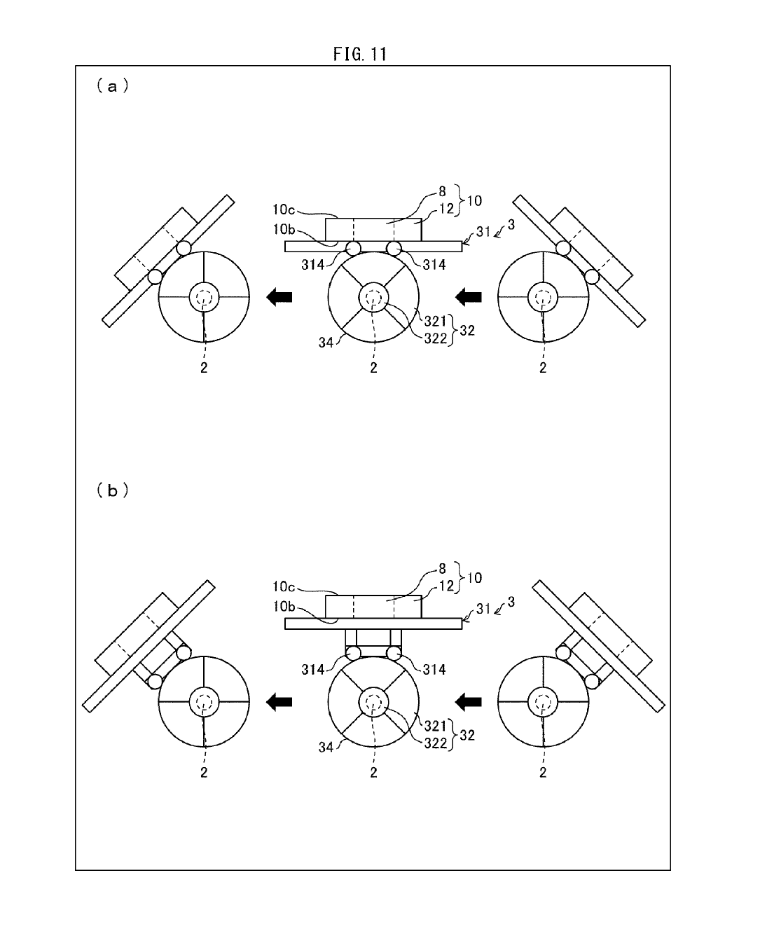

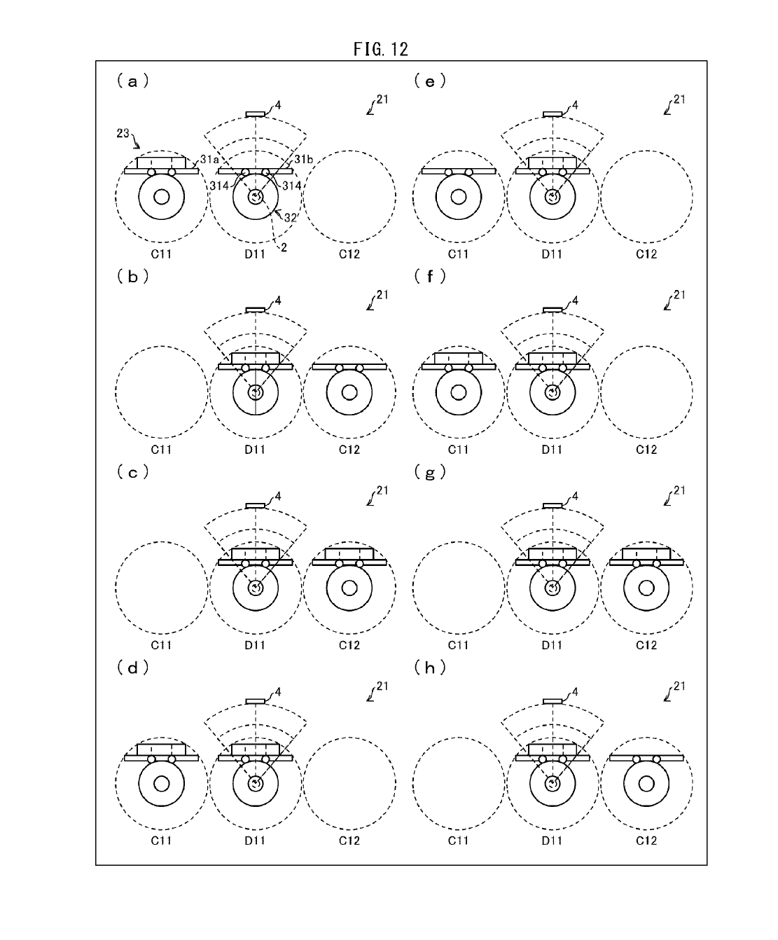

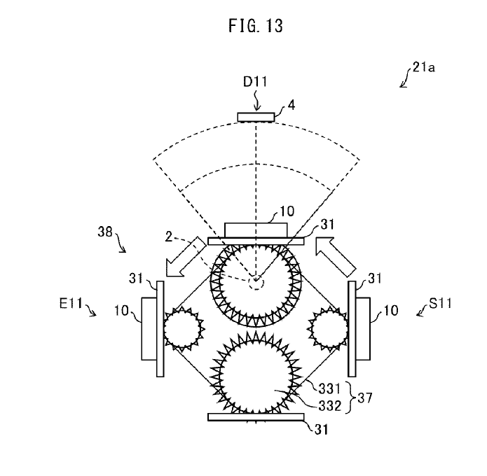

The following description will discuss another embodiment of the present invention with reference to FIGS. 8 to 11. Note that, for convenience of explanation, identical reference numerals are given to members which have respective functions identical with those described in Embodiment 1, and descriptions of the respective members are omitted.

[Configuration of Defect Inspection Device]

FIG. 8 is a diagram schematically illustrating the configuration of a defect inspection device 11 in accordance with Embodiment 2. The defect inspection device 11 in accordance with Embodiment 2 is configured to inspect the separator roll 10 for any foreign object inside the separator 12 while a moving mechanism 13 including a chain conveyor 33 moves the separator roll 10 in a single direction.

Specifically, the defect inspection device 11 detects an electromagnetic wave R having passed through the separator 12 with use of TDI sensors 4 during passage of the separator roll 10 through inspection positions D1 to D4, which are set on a transfer path (first leg) that extends from a placement position S to a removal position E. Further, the defect inspection device 11 rotates the separator roll 10 approximately 45 degrees at each of orientation change positions C1 to C3, which are set on the transfer path. With this configuration, the defect inspection device 11 captures images of different regions of the separator 12 at the inspection positions D1 to D4 and then analyzes those captured images to inspect the separator 12 for any foreign object inside the separator 12.

On the transfer path of the separator roll 10, the orientation change position C1 is set between the inspection position D1 and the inspection position D2, the orientation change position C2 is set between the inspection position D2 and the inspection position D3, the orientation change position C3 is set between the inspection position D3 and the inspection position D4. Further, the orientation change position C4 is set on a return path (second leg) that extends from the removal position E to the placement position S.

Note that the defect inspection device 11 is surrounded by a wall containing, for example, lead to prevent, for example, an X ray from passing therethrough easily so that an electromagnetic wave R used does not leak outward.

As illustrated in FIG. 8, the defect inspection device 11 includes radiation sources 2, the moving mechanism 13, and the TDI sensors 4. The radiation sources 2 and the TDI sensors 4 are disposed at the corresponding inspection positions D1 to D4 in such a manner that the radiation sources 2 correspond one-to-one to the TDI sensors 4. The radiation sources 2 and the TDI sensors 4 are disposed at positions where electromagnetic waves R having passed through the separator 12 can be detected by the TDI sensors during the passage of the separator roll 10 being moved by the moving mechanism 13 through the inspection positions D1 to D4.

(Moving Mechanism 13)

The moving mechanism 13 includes: a mount 31 configured to hold the separator roll 10; and a chain conveyor 33 configured to move the mount 31. The chain conveyor 33 includes two chains 331 and a plurality of gears (sprockets) 332. The mount 31 is connected to the chains 331 via, for example, a spring. The moving mechanism 13 drives the gears 332 to rotate the chains 331, thereby moving the separator roll 10 being held by the mount 31.

(a) of FIG. 9 is a top view illustrating the defect inspection device 11, and (b) of FIG. 9 is a side view illustrating an operating state of the moving mechanism 13 at the inspection position D1. The following description deals with the operating state of the moving mechanism 13 at the inspection position D1. This also applies to the cases for the inspection positions D2 to D4.

As illustrated in (a) of FIG. 9, at the inspection position D1, two circular transfer rollers 34 are disposed on the inner sides of the gears 332 so as to be opposed to each other. Further, at the inspection position D1, two radiation sources 2, each of which emits an electromagnetic wave R radially, are disposed on a center line A of the circular transfer rollers 34.

As illustrated in (b) of FIG. 9, the circular transfer rollers 34 are rotated about the center line A as the coupling rods 314 of the mount 31 having been moved to the inspection position D1 come into contact with the outer peripheral surfaces of the corresponding circular transfer rollers 34. Thus, at the inspection position D1, while the separator roll 10 is moved along the circular path C substantially centered around the radiation source 2 (that is, the separator roll 10 is in circular motion), the TDI sensor 4 can detect the electromagnetic wave R which has passed through the separator 12. This configuration makes substantially equal an angle at which the electromagnetic wave R strikes the separator roll 10, and thus makes it possible to reduce the error in detection position of the TDI sensor 4 which error results from the thickness of the separator roll 10.

(a) to (c) of FIG. 10 are diagrams each illustrating a turning and holding mechanism 35 included in the defect inspection device 11. Specifically, (a) of FIG. 10 is a side view schematically illustrating the turning and holding mechanism 35 provided in the support plate 312 of the mount 31, (b) of FIG. 10 is a top view illustrating orientation changes of a turning plate 351 at the orientation change positions C1 to C3, and (c) of FIG. 10 is a top view illustrating an orientation change of the turning plate 351 at the orientation change positions C4.

As illustrated in (a) of FIG. 10, the defect inspection device 11 is configured such that the turning and holding mechanism 35 configured to turnably hold the separator roll 10 is provided in the support plate 312 of the mount 31. The turning and holding mechanism 35 includes: the turning plate 351 which is provided in the support plate 312 so as to be turnable about a turning shaft 351a; a holding member 352 which is provided so as to protrude through an upper surface of the turning plate 351 and is configured to hold the separator roll 10; and a plurality of orientation change rods 353a to 353d which is provided so as to protrude through a lower surface of the turning plate 351.

The lengths of the orientation change rods 353a to 353d decrease in the following order: (i) the orientation change rod 353b, (ii) the orientation change rod 353c, and (iii) the orientation change rods 353a and 353d. The orientation change rods 353a and 353d are identical in length to each other.

As illustrated in (b) of FIG. 10, a first rail r1 configured to contact the orientation change rod 353b is provided substantially in the shape of an inverted V at the orientation change position C1, which is set downstream from the inspection position D1. When the orientation change rod 353b contacts the first rail r1, the turning plate 351 is rotated approximately 45 degrees. This changes the orientation of the separator roll 10 in such a manner that the separator roll 10 having an orientation at the entry into the inspection position D1 (that is, an initial orientation at the placement position S) is reoriented by a rotation angle of approximately 45 degrees. This allows the separator roll 10 to enter the subsequent inspection position D2.

Further, a second rail r2 configured to contact the orientation change rod 353c is provided substantially in the shape of an inverted V at the orientation change position C2, which is set downstream from the inspection position D2. When the orientation change rod 353c contacts the second rail r2, the turning plate 351 is further rotated approximately 45 degrees. This changes the orientation of the separator roll 10 in such a manner that the separator roll 10 having an orientation at the entry into the inspection position D2 is reoriented by a rotation angle of approximately 45 degrees. This allows the separator roll 10 to enter the subsequent inspection position D3.

Further, a third rail r3 configured to contact the orientation change rod 353d is provided substantially in the shape of an inverted V at the orientation change position C3, which is set downstream from the inspection position D3. When the orientation change rod 353d contacts the third rail r3, the turning plate 351 is further rotated approximately 45 degrees. This changes the orientation of the separator roll 10 in such a manner that the separator roll 10 having an orientation at the entry into the inspection position D3 is reoriented by a rotation angle of approximately 45 degrees. This allows the separator roll 10 to enter the subsequent inspection position D4.

In this manner, the defect inspection device 1 is configured such that the separator roll 10 is rotated approximately 45 degrees at each of the orientation change positions C1 to C3. With this configuration, the defect inspection device 11 performs four image-capturing operations to capture images of different regions of the separator 12 at the inspection positions D1 to D4 and then analyzes those captured images to inspect the separator 12 for any foreign object inside the separator 12.

Further, as illustrated in (c) of FIG. 10, a fourth rail r4 configured to contact the orientation change rod 353b and a fifth rail r5 configured to contact the orientation change rod 353a are each provided substantially in the shape of an inverted V at the orientation change position C4, which is set on a return path (second leg) extending from the removal position E to the placement position S. When the fourth rail r4 contacts the orientation change rod 353b and the fifth rail r5 contacts the orientation change rod 353a, the turning plate 351 is rotated approximately 135 degrees backward. This returns the orientation of the turning plate 351 to its initial orientation. This allows the turning plate 351 to enter the placement position S. Adjustments are made in length of each orientation change rod and in height and arrangement of each rail, so that each rail is so set as to contact only a specific orientation change rod.

The above description in Embodiment 2 has dealt with the defect inspection device 11 configured to perform four image-capturing operations to capture images of different regions of the separator 12 at the inspection positions D1 to D4. However, the configuration of the defect inspection device 11 in accordance with an embodiment of the present invention is not limited to such a configuration. The defect inspection device 11 may perform three or less image-capturing operations or five or more image-capturing operations to capture images of different regions of the separator 12. In this case, inspection positions and orientation change positions are set according to the number of image-capturing operations, and adjustments are made in image-captured range at each inspection position and in angle for orientation change at each orientation change position.

[Recap of Defect Inspection Device]

As described above, the defect inspection device 11 in accordance with Embodiment 2 is configured to include the moving mechanism 13 which includes the chain conveyor 33 and to inspect the separator roll 10 for any foreign object inside the separator 12 while the chain conveyor 33 moves the separator roll 10 in a single direction.

Thus, according to Embodiment 2, it is possible to provide the defect inspection device 11 which can shorten a tact time necessary for defect inspection.

[Modification of Defect Inspection Device]

(a) and (b) of FIG. 11 are side views each illustrating a modification of the mount 31 included in the defect inspection device 11. Specifically, (a) of FIG. 11 illustrates a state in which the separator roll 10 is in a lower position, and (b) of FIG. 11 illustrates a state in which the separator roll 10 is in an upper position.

As illustrated in (a) and (b) of FIG. 11, the mount 31 may include a height adjusting mechanism 36 configured to switch the position of the separator roll 10 between the lower position and the upper position. This configuration makes it possible to change a radius of gyration of a circular path along which the separator roll 10 moves. By changing a distance from the radiation source 2 to the separator 12 with use of the height adjusting mechanism 36, it is possible to change an enlargement ratio of an image captured by the TDI sensor 4.

### Embodiment 3

The following description will discuss still another embodiment of the present invention with reference to FIGS. 12 and 13. Note that, for convenience of explanation, identical reference numerals are given to members which have respective functions identical with those described in Embodiment 1, and descriptions of the respective members are omitted.

[Configuration of Defect Inspection Device]

(a) to (h) of FIG. 12 are diagrams each schematically illustrating the configuration of a defect inspection device 21 in accordance with Embodiment 3 and each illustrating an operating state of the defect inspection device 21. The defect inspection device 21 in accordance with Embodiment 3 is configured to include a first mount 31a and a second mount 31b and to slide the first mount 31a and the second mount 31b and sequentially perform an inspection for any foreign object inside the separator 12.

As illustrated in (a) to (h) of FIG. 12, the defect inspection device 21 includes a radiation source 2, a moving mechanism 23, and a TDI sensor 4.

The radiation source 2 and the TDI sensor 4 are disposed at an inspection position D11. The defect inspection device 21 is configured to capture images of different regions of the separator 12 at the inspection position D11 while the driving section 32 causes the separator roll 10 to make a to-and-fro movement (simple pendulum motion) twice or more times with the radiation source 2 located nearly in the center of the to-and-fro movement. Then, the defect inspection device 21 analyzes the captured images to perform an inspection for any foreign object inside the separator 12.

In the defect inspection device 21, as illustrated in (a) of FIG. 12, a separator roll 10 which has not been inspected is set on the first mount 31a in an initial state in which the first mount 31a is located at a first entry and removal position C11, and the second mount 31b is located at an inspection position D11.

Subsequently, as illustrated in (b) of FIG. 12, the first mount 31a and the second mount 31b are slid. This causes the first mount 31a to move to the inspection position D11 and causes the second mount 31b to move to a second entry and removal position C12. Then, an inspection of the separator roll 10 set on the first mount 31a is started.

Subsequently, as illustrated in (c) of FIG. 12, another separator roll 10 which has not been inspected is set on the second mount 31b during the inspection of the separator roll 10 set on the first mount 31a.

Subsequently, as illustrated in (d) of FIG. 12, the first mount 31a and the second mount 31b are slid after the inspection of the separator roll 10 set on the first mount 31a has been finished. This causes the first mount 31a to move to the first entry and removal position C11 and causes the second mount 31b to move to the inspection position D11. Then, an inspection of the separator roll 10 set on the second mount 31b is started.

Subsequently, as illustrated in (e) of FIG. 12, the separator roll 10, set on the first mount 31a, having been inspected is removed during the inspection of the separator roll 10 set on the second mount 31b.

Subsequently, as illustrated in (f) of FIG. 12, another separator roll 10 which has not been inspected is set on the first mount 31a during the inspection of the separator roll 10 set on the second mount 31b.

Subsequently, as illustrated in (g) of FIG. 12, the first mount 31a and the second mount 31b are slid after the inspection of the separator roll 10 set on the second mount 31b has been finished. This causes the first mount 31a to move to the inspection position D11 and causes the second mount 31b to move to the second entry and removal position C12.

Subsequently, as illustrated in (h) of FIG. 12, the separator roll 10 set on the second mount 31b is removed during the inspection of the separator roll 10 set on the first mount 31a. Then, by repeating the operations illustrated in (c) to (h) of FIG. 12, it is possible to sequentially perform an inspection for any foreign object inside each separator 12.

[Recap of Defect Inspection Device]

As described above, the defect inspection device 21 in accordance with Embodiment 3 includes the moving mechanism 23 configured to slide the first mount 31a and the second mount 31b.

Thus, according to Embodiment 3, it is possible to provide the defect inspection device 21 which can shorten a tact time necessary for defect inspection.

(Modification of Defect Inspection Device)

FIG. 13 is a side view illustrating a modification of the defect inspection device 21. As illustrated in FIG. 13, a defect inspection device 21a includes: a moving mechanism 38 which is configured to include: four mounts 31; and a chain conveyor 37 configured to move the mounts 31. The chain conveyor 33 includes a chain 331 and a plurality of gears (sprockets) 332.

In the defect inspection device 21a, first, a separator roll 10 which has not been inspected is set on the mount 31 at a placement position S11.

Next, the chain conveyor 37 is moved forward so that the separator roll 10 at the placement position S11 is moved to an inspection position D11.

Subsequently, the chain conveyor 37 is moved forward and backward, thereby causing the separator roll 10 to make a to-and-fro movement (simple pendulum motion) twice or more times with the radiation source 2 located nearly in the center of the to-and-fro movement. Further, the separator roll 10 is rotated a predetermined angle during each to-and-fro movement of the separator roll 10 With this configuration, the defect inspection device 21a captures images of different regions of the separator 12 and then analyzes those captured images to inspect the separator 12 for any foreign object inside the separator 12.

Subsequently, while the separator roll 10 is inspected at the inspection position D11, another separator roll 10 not having been inspected is set on the mount 31 at the placement position S11.

Subsequently, the chain conveyor 37 is moved forward after the inspection of the separator roll 10 at the inspection position D11 has been finished. This causes the separator roll 10 having been inspected to move to the removal position E11 and causes the separator roll 10 not having been inspected to move to the inspection position D11. Then, the separator roll 10, set on the mount 31 located at the removal position E11, having been inspected is removed, and another separator roll 10 not having been inspected is set on the mount 31 at the placement position S11.

By repeating the above operations, it is possible to sequentially perform an inspection for any foreign object inside each separator 12.

[Recap]

An inspection device in accordance with an aspect of the present invention includes: a radiation source configured to emit an electromagnetic wave radially to an inspection target object in a thickness direction of the inspection target object; a TDI sensor, disposed opposite from the radiation source with respect to the inspection target object, configured to detect the electromagnetic wave which has passed through the inspection target object; and a moving mechanism configured to move an inspection region of the inspection target object with a distance kept substantially constant between the radiation source and the inspection target object and with a distance kept substantially constant between the radiation source and the TDI sensor.

According to the above configuration, the TDI sensor detects the electromagnetic wave which has passed through the inspection target object, while the inspection region of the inspection target object is moved with a distance kept substantially constant between the radiation source and the inspection target object and with a distance kept substantially constant between the radiation source and the TDI sensor. Thus, it is possible to reduce the error in detection position of the TDI sensor which error results from the thickness of the inspection target object. Thus, according to the above configuration, it is possible to provide an inspection device which can prevent a decreased inspection accuracy resulting from the thickness of the inspection target object.

Further, the inspection device in accordance with an aspect of the present invention may be configured such that the moving mechanism causes the inspection target object to move along a circular path substantially centered around the radiation source.

According to the above configuration, the inspection target object is moved along the circular path substantially centered around the radiation source, so that the inspection region of the inspection target object is moved with a distance kept substantially constant between the radiation source and the inspection target object and with a distance kept substantially constant between the radiation source and the TDI sensor. This makes substantially equal an angle at which the electromagnetic wave strikes the inspection target object. Thus, by detecting the electromagnetic wave which has passed through the inspection target object with use of the TDI sensor, it is possible to reduce the error in detection position of the TDI sensor which error results from the thickness of the inspection target object.

Further, an inspection device in accordance with an aspect of the present invention may be configured such that the moving mechanism causes the inspection target object to make a to-and-fro movement twice or more times between a first position and a second position both of which are located on the circular path.

According to the above configuration, the inspection target object is caused to make a to-and-fro movement twice or more times, so that the electromagnetic wave which has passed through the inspection target object can be detected twice or more times with use of the TDI sensor. Thus, according to the above configuration, it is possible to shorten a tact time necessary for inspection. Moreover, in a case, for example, where the detection for each portion of the inspection target object is performed twice or more times with use of the TDI sensor, it is possible to shorten a tact time necessary for inspection of the entire inspection target object.

Still further, the inspection device in accordance with an aspect of the present invention may be configured such that the TDI sensor detects the electromagnetic wave which has passed through the inspection target object, while the inspection target object is moved from the first position to the second position.

According to the above configuration, the TDI sensor detects the electromagnetic wave which has passed through the inspection target object, while the inspection target object is moved from the first position to the second position. Thus, according to the above configuration, it is possible to suitably perform, with use of the TDI sensor, detection of the electromagnetic wave which has passed through the inspection target object moving in a single direction.

Yet further, an inspection device in accordance with an aspect of the present invention may be configured such that the moving mechanism causes the inspection target object to rotate substantially about a shaft extending in the thickness direction, while the inspection target object is moved from the second position to the first position.

According to the above configuration, the inspection target object is rotated while the inspection target object is moved from the second position to the first position. Thus, according to the above configuration, it is possible to perform, with use of the TDI sensor, detection of the electromagnetic wave which has passed through different regions of the inspection target object, during each to-and-fro movement of the inspection target object. Moreover, since the inspection target object is rotated while the inspection target object is moved from the second position to the first position, it is possible to shorten a tact time necessary for inspection.

Further, an inspection device in accordance with an aspect of the present invention may be configured such that the TDI sensor detects the electromagnetic wave which has passed through the inspection target object, while the inspection target object is moved from the first position to the second position and while the inspection target object is moved from the second position to the first position.

According to the above configuration, the TDI sensor detects the electromagnetic wave which has passed through the inspection target object, both while the inspection target object is moved on the circular path from the first position to the second position and while the inspection target object is moved from the second position to the first position. Thus, according to the above configuration, it is possible to efficiently perform, with use of the TDI sensor, detection of the electromagnetic wave which has passed through the inspection target object moving in two directions.

Still further, an inspection device in accordance with an aspect of the present invention may be configured such that the moving mechanism causes the inspection target object to rotate substantially about a shaft extending in the thickness direction, at a time when the inspection target object has reached the second position from the first position and at a time when the inspection target object has reached the first position from the second position.

According to the above configuration, the inspection target object is rotated both at the time when the inspection target object has reached the second position from the first position and at the time when the inspection target object has reached the first position from the second position. Thus, according to the above configuration, it is possible to perform, with use of the TDI sensor, detection of the electromagnetic wave which has passed through two different regions of the inspection target object, during each to-and-fro movement of the inspection target object. This makes it possible to shorten a tact time necessary for inspection of the entire inspection target object.

Yet further, an inspection device in accordance with an aspect of the present invention may be configured such that the inspection target object is substantially circular in outer shape when viewed from the thickness direction.

An inspection device in accordance with an aspect of the present invention can also be suitably used for an inspection target object which is substantially circular in outer shape when viewed from the thickness direction.

Further, an inspection device in accordance with an aspect of the present invention may be configured such that the inspection target object is a film roll that includes (i) a cylindrical core and (ii) a film wound around an outer peripheral surface of the core.

An inspection device in accordance with an aspect of the present invention can be suitably used particularly for an inspection target object of a relatively large thickness, such as a film roll that includes (i) a cylindrical core and (ii) a film wound around an outer peripheral surface of the core.

Still further, an inspection device in accordance with an aspect of the present invention may be configured such that the electromagnetic wave is an X ray.

According to the above configuration, it is possible to inspect an inspection target object with use of an X ray. The above configuration also makes it possible to provide an inspection device that is inexpensive and easy to use.

An inspection method in accordance with an aspect of the present invention includes: an emitting step including emitting an electromagnetic wave radially from a radiation source to an inspection target object in a thickness direction of the inspection target object; a moving step including moving an inspection region of the inspection target object; and a detecting step including detecting, with use of a TDI sensor, the electromagnetic wave which has passed through the inspection target object, the moving step including moving the inspection region with a distance kept substantially constant between the radiation source and the inspection target object and with a distance kept substantially constant between the radiation source and the TDI sensor.

According to the above method, the electromagnetic wave which has passed through the inspection target object is detected with use of the TDI sensor, while the inspection region of the inspection target object is moved with a distance kept substantially constant between the radiation source and the inspection target object and with a distance kept substantially constant between the radiation source and the TDI sensor. Thus, it is possible to reduce the error in detection position of the TDI sensor which error results from the thickness of the inspection target object. Thus, according to the above method, it is possible to provide an inspection method which can prevent a decreased inspection accuracy resulting from the thickness of the inspection target object.

A method of producing a film roll in accordance with an aspect of the present invention may include a defect inspecting step including subjecting a film roll that includes (i) a cylindrical core and (ii) a film wound around an outer peripheral surface of the core to inspection for a defect in the film by an inspection method in accordance with the present invention.

According to the above method, it is possible to produce a film roll that contains only a small number of defects such as a foreign object.

Further, the method of producing a film roll in accordance with an aspect of the present invention may further include: a slitting step including slitting an original sheet so as to prepare the film, the original sheet having a width larger than a width of the film; a film winding step including winding the film, prepared in the slitting step, around the core so as to produce the film roll; and a packaging step including packaging the film roll, produced in the film winding step, wherein the defect inspecting step is carried out after the slitting step and before the packaging step.

The above method makes it possible to efficiently inspect, during the defect inspecting step, a film for any foreign object resulting from the slitting step, during which a foreign object tends to result. The above method also makes it possible to save the trouble of, after a film roll has been packaged, inspecting the film roll for a foreign object adhering to the film.

A method of producing a film roll in accordance with an aspect of the present invention may be further configured such that the defect inspecting step includes inspecting the film roll for a foreign object that is not less than 100 μm.

The above method makes it possible to produce a film roll that contains only a small number of foreign objects which are not less than 100 μm or that contains no such foreign object.

Note that a film roll in accordance with an aspect of the present invention may be produced by the method of producing a film roll in accordance with any of the aspects of the present invention. This configuration makes it possible to produce a separator roll containing only a small number of defects such as a foreign object.

Further, a film roll in accordance with an aspect of the present invention is a separator roll including: a tubular core; and a separator for use in a battery which separator is wound around the core, the separator roll containing, inside the separator, no foreign object that is not less than 100 μm. This configuration makes it possible to produce a separator roll with a low possibility that a foreign object adhering to the separator causes a failure.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Defect inspection device (inspection device)
2: Radiation source
3, 3a, 3b, 13, 23, 38: Moving mechanism
4: TDI sensor
8: Core
10: Separator roll (inspection target object, film roll)
C: Circular path
12: Separator (film)
P1: First position
P2: Second position
R: Electromagnetic wave (X ray)

1. An inspection device comprising:
a radiation source configured to emit an electromagnetic wave radially to an inspection target object in a thickness direction of the inspection target object;
a TDI sensor, disposed opposite from the radiation source with respect to the inspection target object, configured to detect the electromagnetic wave which has passed through the inspection target object; and
a moving mechanism configured to move an inspection region of the inspection target object with a distance kept substantially constant between the radiation source and the inspection target object and with a distance kept substantially constant between the radiation source and the TDI sensor.

2. The inspection device according to claim 1, wherein the moving mechanism causes the inspection target object to move along a circular path substantially centered around the radiation source.

3. The inspection device according to claim 2, wherein the moving mechanism causes the inspection target object to make a to-and-fro movement twice or more times between a first position and a second position both of which are located on the circular path.

4. The inspection device according to claim 3, wherein the TDI sensor detects the electromagnetic wave which has passed through the inspection target object, while the inspection target object is moved from the first position to the second position.

5. The inspection device according to claim 4, wherein the moving mechanism causes the inspection target object to rotate substantially about a shaft extending in the thickness direction, while the inspection target object is moved from the second position to the first position.

6. The inspection device according to claim 3, wherein the TDI sensor detects the electromagnetic wave which has passed through the inspection target object, while the inspection target object is moved from the first position to the second position and while the inspection target object is moved from the second position to the first position.

7. The inspection device according to claim 6, wherein the moving mechanism causes the inspection target object to rotate substantially about a shaft extending in the thickness direction, at a time when the inspection target object has reached the second position from the first position and at a time when the inspection target object has reached the first position from the second position.

8. The inspection device according to claim 1, wherein the inspection target object is substantially circular in outer shape when viewed from the thickness direction.

9. The inspection device according to claim 8, wherein the inspection target object is a film roll that includes (i) a cylindrical core and (ii) a film wound around an outer peripheral surface of the core.

10. The inspection device according to claim 1, wherein the electromagnetic wave is an X ray.

11. An inspection method comprising:
an emitting step comprising emitting an electromagnetic wave radially from a radiation source to an inspection target object in a thickness direction of the inspection target object;
a moving step comprising moving an inspection region of the inspection target object; and
a detecting step comprising detecting, with use of a TDI sensor, the electromagnetic wave which has passed through the inspection target object,
the moving step including moving the inspection region with a distance kept substantially constant between the radiation source and the inspection target object and with a distance kept substantially constant between the radiation source and the TDI sensor.

12. A method of producing a film roll, comprising:
a defect inspecting step comprising subjecting a film roll that includes (i) a cylindrical core and (ii) a film wound around an outer peripheral surface of the core to inspection for a defect in the film by an inspection method recited in claim 11.

13. The method of producing a film roll according to claim 12, further comprising:
a slitting step comprising slitting an original sheet so as to prepare the film, the original sheet having a width larger than a width of the film;
a film winding step including winding the film, prepared in the slitting step, around the core so as to produce the film roll; and
a packaging step including packaging the film roll, produced in the film winding step,
wherein the defect inspecting step is carried out after the slitting step and before the packaging step.

14. The method of producing a film roll according to claim 12, wherein the defect inspecting step comprises inspecting the film roll for a foreign object that is not less than 100 μm.
